(19) United States
(12) Patent Application Publication
(10) Pub. No.: US 2005/0078850 A1
(43) Pub. Date: Apr. 14, 2005

(54) Audio loudspeaker

(76) Inventor: John M. Norton, Tujunga, CA (US)

Correspondence Address: John F. Letchford;Klehr, Harrison, Harvey, Branzburg & Ellers LLP, 260 South Broad Street, Philadelphia, PA, 19102, US

(21) Appl. No.: 10/936,160

(22) Filed: Sep. 8, 2004

Related U.S. Application Data
(60) Provisional application No. 60/500,913, filed on Sep. 8, 2003.
(60) Provisional application No. 60/519,774, filed on Nov. 13, 2003.
(60) Provisional application No. 60/519,869, filed on Nov. 13, 2003.

(51) Int. Cl. H04R 1/00; H04R 1/20

(52) U.S. Cl. 381/423; 381/424

(57) ABSTRACT

The invention describes the incorporation of surface irregularities into a loudspeaker diaphragm to control the resonances of diaphragm. Through the use of the described resonance control techniques, a single loudspeaker driver is able to offer excellent performance over a wide range of the audio spectrum. The randomness of the selected features is constrained within a set of boundary conditions to accomplish a balance of achieving the desired performance, as well as ensure that the device is practical to manufacture.

### CROSS-REFERENCE TO RELATED APPLICATIONS

This application claims the benefit of U.S. Provisional Application No. 60/500,913, filed Sep. 8, 2003, entitled “Boundary Constrained Randomness for Loudspeaker Diaphragms”; U.S. Provisional Application No. 60/519,774, filed Nov. 13, 2003, entitled “Loudspeaker Diaphragms with Randomized Edges”; and U.S. Provisional Application No. 60/519,869, filed Nov. 13, 2003, entitled “Loudspeaker Diaphragms with Resonance Reducing Perforations”.

### FIELD OF THE INVENTION

The present invention relates in general to audio loudspeakers and in particular to a loudspeaker system that enables a single speaker driver to offer excellent performance over a wide range of the audio spectrum. In the present context, the terms “loudspeaker” and “speaker” are synonymous and are used interchangeably herein.

### BACKGROUND OF THE INVENTION

A diaphragm is the sound emitting component of a loudspeaker driver. A cross-sectional view of a typical loudspeaker driver is shown in FIG. 1, with the diaphragm and other basic components of the speaker noted therein. Typically, the diaphragm is round in shape, but other shapes such as ovals and squares have been used. The diaphragm is usually not flat, but has a certain amount of depth from the inner edge to the outer edge. When employed for a loudspeaker diaphragm, this depth results in three-dimensional shapes such as a cones and domes having smooth radiating surfaces and edges.

Inherent in these shapes are resonances that taint or color the sound generated by the diaphragm and limit its usable operating frequency range. The most common shape for loudspeaker diaphragms covering the lower frequency of the audible spectrum is the cone. It is well known in the art that cone diaphragms exhibit so-called “bell mode resonances.” Bell mode resonances reduce the usable frequency range of the diaphragm by causing the diaphragm to resonate at frequencies that are proportional to the dimensions of the diaphragm. FIG. 2 depicts the bell mode resonances of a typical cone diaphragm. These resonances are a byproduct of the sound wave transmission in the diaphragm from the motive connection (motor coil) at the inner apex of the cone to the outer edge of the cone.

An illustration of the effect of bell mode resonances on a driver's output relative to frequency is shown in FIG. 3. As seen therein, bell mode resonances introduce uneven frequency response. This instability strongly attenuates those frequencies above the onset of the bell mode resonances. A generalized view of sound transmission through a cone-shaped diaphragm having smooth radiating surfaces and edges is illustrated in vector form in FIG. 4. In this example, the sound wave originates at the connection to the electro-dynamic motor in the center of the cone and radiates toward the outer edge of the cone. The smooth surfaces and edges used in presently available cone diaphragms allow a portion of the acoustic wave to be reflected back toward the center of the diaphragm over a wide frequency range, thereby contributing to bell mode resonances. This behavior dictates that a plurality of differently sized drivers be used in a loudspeaker system to reproduce a substantial amount of the audible spectrum.

A commonly used shape for high frequency diaphragms is the hemisphere or “dome.” A cross-sectional view of a typical dome shaped diaphragm is illustrated in FIG. 5. It is known in the art that the dome exhibits behavior similar to the cone's bell mode resonances over a frequency range that is proportional to the dimensions of the dome. One of the physical phenomena that imposes a limit on the useful frequency range of a conventional dome speaker driver is known as “breakup mode.” In breakup mode, higher frequency waves are unable to propagate in a controlled fashion across the surface of the diaphragm. This results in large peaks and dips in the frequency response of a traditional dome speaker driver. Breakup mode occurs because of the limitations of the physical properties of the materials used to construct the speaker diaphragm. FIG. 6 illustrates the detrimental effect of these resonant nodes that contribute to the dome's output relative to frequency response. Dome resonant nodes are found to occur dome heights (h) of λ/2, 3λ/2, 5λ/2, and so on (where λ is the wavelength being emitted by the diaphragm). FIG. 6 also depicts the speaker performance effect known as “phase loss.” Phase loss also works against a conventional speaker driver's ability to provide usable response over the entire audible range. This phenomenon is a function of propagation delay as the wave moves away from the motive connection of the diaphragm. The amount of delay from the center to the outer edge of a diaphragm typically varies according to frequency. This effect causes signals emanating from the various regions of the diaphragm to arrive at the listener at varying degrees out of phase.

A generalized view of the sound transmission through a dome-shaped diaphragm with smooth surfaces and edges is illustrated in vector form in FIG. 7. In this example, the sound wave originates at the connection to the electrodynamic motor and radiates towards the opposite edge of the dome. The smooth radiating surfaces and edges used in dome diaphragms allow a portion of the acoustic wave in the diaphragm to be reflected back over a wide frequency range, thereby contributing to undesirable dome resonances similar to the bell mode resonances associated with cone diaphragms.

Traditionally, multi-way speaker systems have several speaker drivers of varying sizes to facilitate reproduction of the full range of audible frequencies. As used herein, the term “multi-way” shall be construed to mean a speaker system that employs a first speaker for emitting sound at low frequencies (e.g., a woofer) and at least one additional speaker for emitting sound at comparatively higher frequencies. An example of a conventional multiple-way speaker is shown in FIG. 8. Larger speaker drivers are used to reproduce low frequencies, with progressively smaller drivers used to reproduce progressively higher frequencies. The various speaker drivers are connected to an electrical signal that is frequency limited to accommodate the specific capabilities of each speaker driver. As described below, frequency limiting is performed with electrical components either at the output of the driving amplifier, or at the input to a number of amplifiers.

There are two primary interconnection topologies in use for multi-way speaker systems. A typical circuit diagram of the “passive crossover” type, shown in FIG. 9, accomplishes frequency limiting for each device driver through direct connection to the output of an amplifier, with electrical components dividing up the full audible frequency range into frequency bands that are suited to each driver. The “active crossover” type, a typical circuit diagram of which is shown in FIG. 10, performs frequency dividing before the input to the amplifier associated with each loudspeaker component, so that the loudspeaker component can be connected directly to its dedicated amplifier output.

Due to frequency-dependent phase shift inherent in both of types of crossover designs, there is degradation in the audio signal being received by each of the speaker components covering the selected audible range. This phase shift is further aggravated by the physical displacement of each of the multi-way speaker components in the speaker enclosure with respect to one another (which displacement, in turn, is limited by mounting constraints within the speaker enclosure). For passively crossed over speaker systems, there are additional degradations in signal quality since the crossover components must divide up full range amplifier signals ranging from several watts to many hundreds of watts. A resultant degradation is the loss of power absorbed in the crossover, often referred to “insertion loss.” Further distorting the signal delivered to the speaker is the intrinsic variation of the loss with varying power levels.

Where active crossovers are employed, some of the passive crossover deficiencies are resolved. Nevertheless, the imperfections of phase distortion and overlapping frequency response remain, although factors such as signal level variations on the crossover element are reduced. However, this topology does require a separate amplifier and cabling for each loudspeaker driver, and that has a significant increase on the cost and the potential reduction of reliability for this sound system topology.

Still another impediment to the ability of a traditional loudspeaker to achieve a wide range of frequency response is related to phase. Phase is impacted by the accepted nominal diaphragm surface area for radiating progressively higher frequencies. Since wavelengths for increasingly higher frequencies become progressively smaller, the radiating area must be proportionately smaller as the frequency response increases. Consequently, phase interference from differing and physically separated sources causes phase node and anti-node phenomena at a variety of angular offsets and distances from the high frequency radiating surface. This design criteria has been a traditional motivation for the increasingly smaller diaphragms used in conventional multi-way full range speaker system.

Attempts have been made to address the general issue of audio distortion caused by “standing” and “transverse” waves in a speaker cone. A standing wave is a wave which oscillates but does not propagate. A transverse wave is a wave in which the oscillation is perpendicular to the direction of wave propagation. U.S. Pat. No. 5,304,746, for example, describes the use of regular patterns of small blocks to reduce standing waves and distortion in an audio transducer. The blocks are placed in a specific order, i.e., in two parallel annular rows near the outer edge of the speaker diaphragm. And, U.S. Pat. No. 5,689,093 discusses a method to reduce transverse wave distortion in a speaker cone. In this design, small fibers are implanted in and project perpendicularly from the inner and/or outer surface(s) of the cone to reduce transverse waves. No particular order or arrangement is specified for the implanting of the fibers, nor is there any expression of a relationship between fiber density and wave absorption performance. While these methodologies may improve speaker audio quality, they do not enhance versatility. In other words, they do not expand the range of the audible spectrum within which a given speaker is designed to perform: a woofer remains a woofer, a midrange remains a midrange, a tweeter remains a tweeter, and so on.

Notwithstanding available methodologies for dampening speaker distortion presented by the prior art, a multi-way speaker system nonetheless requires multiple speaker diaphragms of differing sizes, multiple drivers, multiple speaker suspension parts, and either multiple amplifiers or multiple electronic filtering means in order to service the full range of the audio spectrum. The result is that conventional speaker systems are complex in design and expensive to manufacture.

An advantage exists, therefore, for a loudspeaker system that employs a single speaker that effectively radiates audio signals across the audible spectrum. So equipped, such a system would require only one amplifier and a single set of speaker suspension parts, thereby resulting in a loudspeaker of simple and compact design and comparatively lesser manufacturing cost than conventional multi-way speakers. In addition, phase-related and other distortions that affect conventional multi-way speakers would be ameliorated.

### SUMMARY OF THE INVENTION

The present invention eliminates the need for a plurality a speakers of various sized components to cover the full audio range. Through the use of a novel design approach, a single loudspeaker is capable of accommodating essentially the entire audible frequency spectrum (about 20 Hz to about 20 kHz).

In particular, the present invention relies on surface irregularities intentionally incorporated into a speaker's diaphragm in order to achieve wide-range frequency performance from a single loudspeaker. In other words, in contrast to traditional speaker design methodologies which endeavor to produce structurally perfect or idealized speaker diaphragms, the present invention exploits previously unexpected performance advantages arising from structural imperfections intentionally introduced into speaker diaphragms.

The present invention seeks to anticipate the series of nodal resonances inherent in radiating surfaces, and provide design elements that allow smooth transition between the various nodal orders while simultaneously diffusing the magnitude of each nodal order. According to the invention, the key to diffusing the series of nodal resonant series inherent in any pressure wave radiating surface, such as the radiating surface of a conically-shaped or dome-shaped speaker diaphragm, is to introduce resonance reducing structural features into the diaphragm that are, preferably, random in nature and impart an irregular radiating surface to the diaphragm.

The present invention offers an array of approaches to mitigate undesirable resonances in a pressure wave radiating surface. One is to provide three-dimensional structural features such as projections and/or depressions formed in relief with respect the radiating surface. Such structural features are preferably irregularly shaped and may assume the form of ribs, stalks or veins or other three-dimensional shapes. Additional benefits flowing from the use of structural features configured as ribs, stalks or veins is that they are easily formed in the diaphragm fabrication process and add dimensional stiffness to the diaphragm, which is useful when it is functioning in the low frequency “piston” mode of operation. Other arbitrary shapes may also be used so long as they also randomize and therefore mitigate the intrinsic resonances in a given base geometric structure, regardless of whether that structure is a cone, flat panel, ellipse or any other shape which is required for a given sound reproduction application.

Another way in which the present invention introduces diaphragm structural randomness as a means to mitigate resonances is to provide apertures in the radiating surface of a diaphragm. The apertures may assume any shape and size within the dimensional constraints of the diaphragm.

Yet another way to introduce beneficial structural randomness is to provide the outer peripheral edge of the diaphragm with an irregular edge where it is joined to the roll surround or suspension material.

Still further, a diaphragm may also be constructed that incorporates any combination of the foregoing approaches to exploit structural randomness as a means to mitigate and desirably eliminate unwanted resonances.

A speaker diaphragm that uses any one or more of the resonance mitigation schemes described herein results in a loudspeaker system that employs a single speaker to effectively radiate audio signals across the audible spectrum and one that is less expensive to manufacture than conventional multi-way speaker systems.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a cross-sectional view of a conventional cone-type loudspeaker;

FIG. 2 is a depiction of bell mode resonances that occur in conventional cone-type loudspeakers;

FIG. 3 is a graph of nodal resonances that occur in conventional cone-type loudspeakers as a function of frequency;

FIG. 4 is a schematic view of source and reflected waves that occur in a conventional cone-type loudspeaker diaphragm;

FIG. 5 is a cross-sectional view of a conventional dome-type loudspeaker;

FIG. 6 is a graph of nodal resonances that occur in conventional dome-type loudspeakers as a function of frequency;

FIG. 7 is a schematic view of source and reflected waves that occur in a conventional dome-type loudspeaker diaphragm;

FIG. 8 is a perspective view of a conventional multi-way speaker system;

FIG. 9 is a circuit diagram of a passive crossover employed in a conventional multi-way speaker system;

FIG. 10 is a circuit diagram of an active crossover employed in a conventional multi-way speaker system;

FIG. 11 is a perspective view of a first embodiment of a cone-type loudspeaker diaphragm according to the present invention;

FIG. 12 is a plan view of a further embodiment of a cone-type loudspeaker diaphragm according to the present invention;

FIG. 13 is a plan view of a further embodiment of a cone-type loudspeaker diaphragm according to the present invention;

FIG. 14 is a plan view of a further embodiment of a cone-type loudspeaker diaphragm according to the present invention;

FIG. 15 is a plan view of a further embodiment of a cone-type loudspeaker diaphragm according to the present invention;

FIG. 16 is a schematic view of source and reflected waves that occur in the cone-type loudspeaker diaphragm of FIG. 15;

FIG. 17 is a schematic view of source and reflected waves that occur in a dome-type loudspeaker diaphragm constructed analogously to the cone-type loudspeaker diaphragm of FIG. 15;

FIG. 18 is a plan view of a further embodiment of a cone-type loudspeaker diaphragm according to the present invention;

FIG. 19 is a plan view of a further embodiment of a cone-type loudspeaker diaphragm according to the present invention;

FIG. 20 is an enlarged view of a portion of the cone-type loudspeaker diaphragm of FIG. 19;

FIG. 21 is a schematic view of source and reflected waves that occur in the cone-type loudspeaker diaphragm of FIG. 19;

FIG. 22 is a schematic view of source and reflected waves that occur in a dome-type loudspeaker diaphragm constructed analogously to the cone-type loudspeaker diaphragm of FIG. 19: and

FIG. 23 is a frequency graph demonstrating the performance of a loudspeaker constructed according to the present invention.

### DETAILED DESCRIPTION OF THE INVENTION

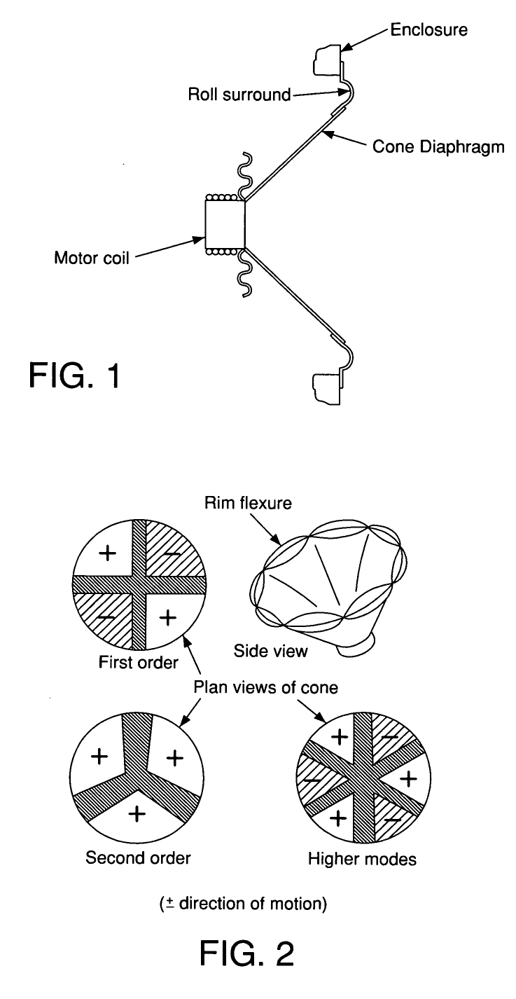

The present invention describes the use of a conventional electro-dynamic motor as the excitation force on the diaphragm similar to that shown in FIG. 1. Such a motor is comprised of a voice coil wound on a voice coil former, held in a strong magnetic field by the use of a “spider” support and the diaphragm roll surround. This type of electro-dynamic speaker is by far the most prevalent type in use today. However, the design principles described herein for resonance control are also applicable to other electro-motive techniques such as those employed by electrostatic speakers.

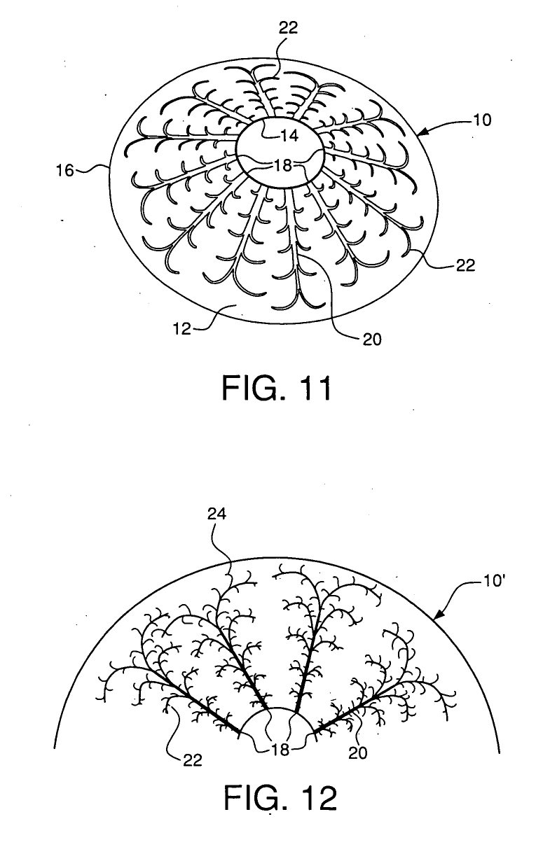

Referring to the drawings, there is shown in FIG. 11 a first embodiment of a loudspeaker diaphragm constructed in accordance with the present invention. The diaphragm, identified generally by reference numeral 10, is constructed as a cone-type diaphragm comprised of a conical pressure wave radiating surface 12 having an inner edge or apex 14 and an outer edge or rim 16. As is conventional, apex 14 is adapted to be joined to an unillustrated electromotive voice coil and rim 16 is adapted to be joined to an unillustrated roll surround or suspension. Diaphragm 10 may be manufactured from injection molded plastic such as polycarbonate, although other molding techniques (e.g., vacuum molding) and other materials (e.g., other plastics or paper) may be employed to manufacture the diaphragm to desired specifications. However, for optimum speaker driver performance, it is preferred that engineered materials (i.e., plastics) having predictable physical properties such as Young's modulus of elasticity and bulk specific gravity be used to form the diaphragm.

Pursuant to the first embodiment of the invention, radiating surface 12 is provided with surface irregularities in the form of three-dimensional structural features 18. The three-dimensional structural features may assume the form of projections and/or depressions formed in relief with respect to the radiating surface. The height and/or depth of structural features 18 is constrained to an elevation suitable for effective manufacture of diaphragm 10. Structural features 18 are preferably irregular in shape and may assume any three-dimensional shape or shapes for achieving the objects of the present invention.

Although they may be randomly arranged on the radiating surface of diaphragm 10, in the illustrative but non-limitative example shown in FIG. 11, three-dimensional structural features 18 are constructed as a plurality of formations resembling ribs, stalks or veins that extend radially outward from the center or apex 14 of the cone to the outer edge 16. It is also preferable that they interleave with other such structural features. As a result, randomly sized and shaped sub-regions of the radiating surface 12 remain flat relative to the three-dimensional structural features. Structural features 18 comprise at least a primary portion 20 and may also include higher order and progressively narrower appendant secondary portions 22 extending from the primary portion to further interrupt the flatness of the radiating surface of the diaphragm. In addition to the relatively simple three-dimensional structural features 18 shown in FIG. 11, there are essentially unlimited structural variations that may accomplish very specific levels of resonance control to compensate for inadequacies in the materials used in fabrication, specific adaptations to physical design constraints and the preferences of target groups of end users of the speaker.

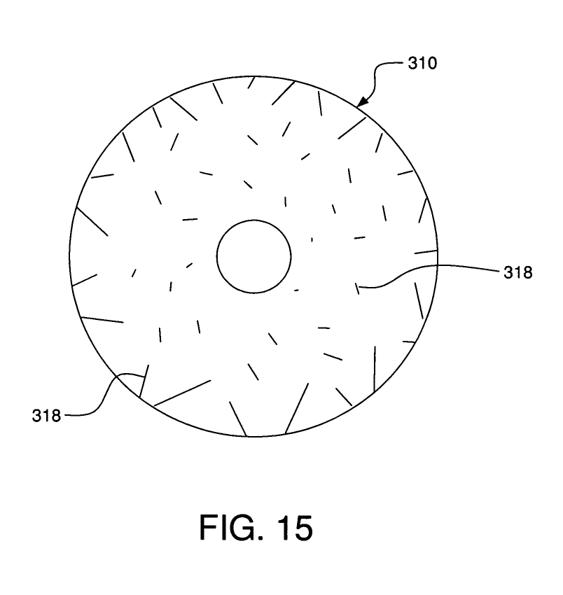

FIG. 12 illustrates an example of another conical diaphragm 10′ in which higher order vein-like three-dimensional structural features 18 are present. Specifically, in addition to primary portion 20 and secondary portions 22, structural features 18 further include smaller tertiary portions 24 that help to further randomize the various flat regions of the diaphragm. Even higher order randomized structural features are possible. Regardless of the types of surface irregularities that may be provided in the speaker driver diaphragms of the present invention, they are constrained within a set of boundary conditions including diaphragm size and geometry, material properties, width and height of three-dimensional structural features, relief or sculpture pattern geometry and, in specific respect to the embodiments of the present invention illustrated in FIGS. 15 and 18, aperture sizes and shapes. Moreover, although the diaphragm surface irregularities shown in FIGS. 11 and 12 and several later figures are described in association with a cone-type diaphragm, they may be employed as well in dome-type or other diaphragms. Likewise, any diaphragm surface irregularities described herein in connection with dome-type diaphragms may be adapted for use in cone-type or other diaphragms. Further, in the case of cone-type diaphragms, the unillustrated voice coil center cone (or “dust cap”) may also include three-dimensional structural features that that are similar to or dissimilar from the features of the main diaphragmatic structure.

In the examples shown in FIGS. 11 and 12, the randomness is constrained by the number of structural features 18 including the number of their primary and higher order offshoots. Combined with appropriate measurement data, additional compensation can be achieved for specific requirements of differing physical dimensions, varying magnetic field strengths and voice coil length.

The present inventor has observed that structural randomness is highly relevant to eliminating identical resonant frequencies in the uninterrupted flat sub-regions of the radiating surface of the diaphragm. Ideally, each sub-region is asymmetrical in shape to reduce the tendency towards resonance. However, given the tendency of all surfaces towards resonance, the use of varied sizes and shapes of the sub-regions effectively eliminates a dominant resonance frequency for a diaphragm on a macro level.

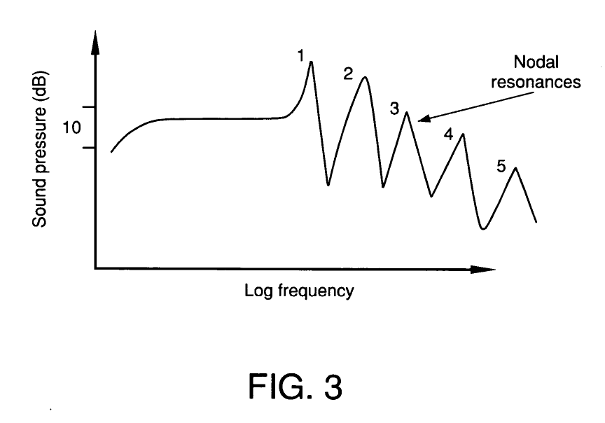

In the classical representation of nodal resonances, exemplified in FIG. 3, the symmetry of resonant nodes are clearly evident. The present invention enhances conventional speaker diaphragm geometry and thereby disrupt the formation of resonant nodes. It does this via three-dimensional structural features, or as described later herein, apertures, edge region surface irregularities, or any combination thereof, which produce randomized geometries into the otherwise uniform and symmetrical structure of the diaphragm. The resultant advantages are manifold:
Reduced and diffused intrinsic nodal resonances endemic in any base diaphragm geometric structure to enable a driver to provide usable response over the full spectrum of audible frequencies.
Reduced radiating area of the diaphragm as frequencies increase.
Enhanced rigidity of the diaphragm in the low frequency, “piston” mode of operation.
Enhancements are constrained to practical levels of material draw (the flow characteristics of plastics during the diaphragm molding process), improved reliability or other attribute of consideration in the manufacture or end use of the product.

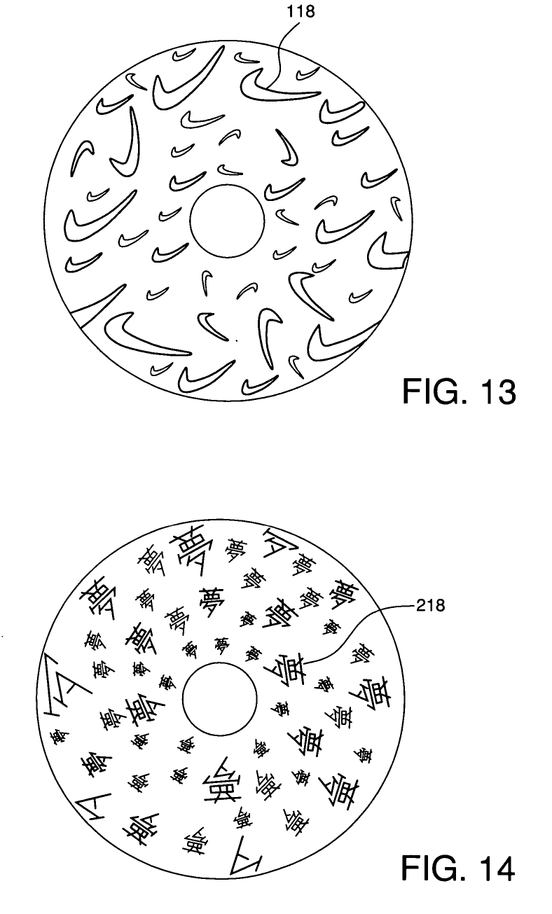

In addition, the aesthetic characteristics of the resonance reducing three-dimensional structural features are virtually infinite. That is, essentially any conceivable form of randomized indicia can be used to create resonance reducing surface irregularities on speaker diaphragms according to the present invention. FIGS. 13 and 14 reveal widely divergent examples of surface irregularities that may be formed in relief into the radiating surface of a speaker diaphragm. As shown by those figures, the three-dimensional structural features can employ a variety of “seed patterns” to accomplish desired design objectives. By way of illustration but not limitation, the seed pattern can be a corporate logo 118 (e.g., the familiar Nike, Inc. “swoosh” logo, FIG. 13), or whimsical patterns such as flowers, fractals, geometric shapes such as honeycombs, or images such as Japanese Kanji characters 218 (FIG. 14). It is worthy to note that both of the three-dimensional structural features seed patterns examples shown in FIGS. 13 and 14 are constrained according to the same density plot, but yet use starkly different structural details to accomplish the same diaphragmatic performance.

Resonance control of a diaphragm must also address the level at which higher frequencies propagate. At lower frequencies the diaphragm moves rectilinearly, which is often called the “piston” mode of operation. In addition, there is a transition frequency where the diaphragm begins to act like a wave transmission medium. The transition frequency is proportionate to the size of the diaphragm and has a wavelength approximately equal to the effective radiating diameter of the diaphragm (approximately the distance from the apex to the rim). At frequencies above the transition frequency, the resonance reducing features attenuates the frequencies in a controlled manner, proportional to the rate of frequency. This has the effect of reducing the radiating surface area as frequencies increase, which is an important consideration with regard to the dispersion of high frequencies. With the progressively smaller wavelengths, it is essential to maintain the radiating surface area of the diaphragm below a half wavelength to prevent phase cancellation and phase interference at higher frequencies.

The diaphragm of the predominant cone based speaker is sometimes considered to be only the larger outer section, and not what is typically called the voice coil center cone or “dust cap.” For the present invention, this center section of the diaphragm is considered to be an extension of the diaphragm, and the features relating to constrained structural randomness described herein are applicable to it as well.

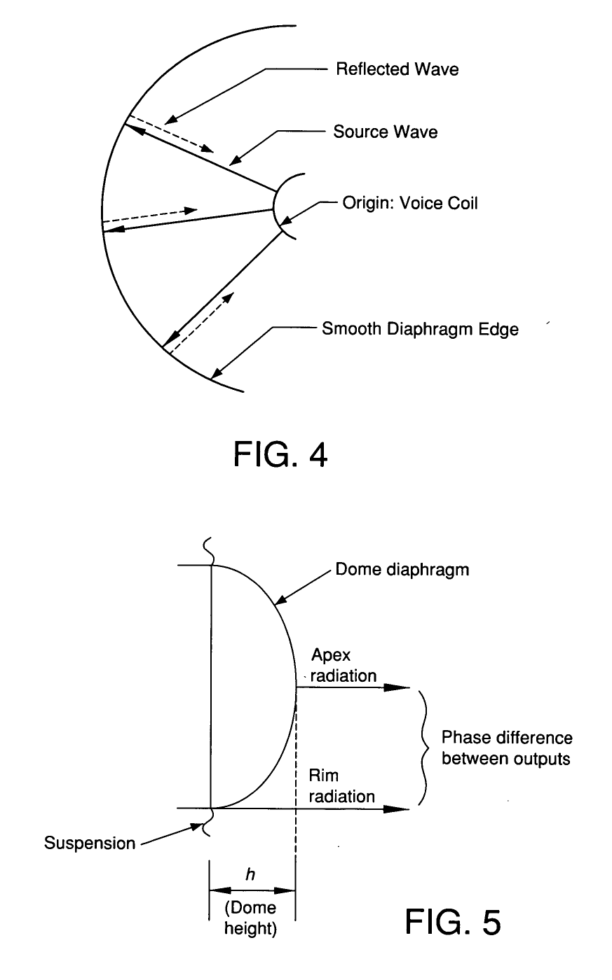

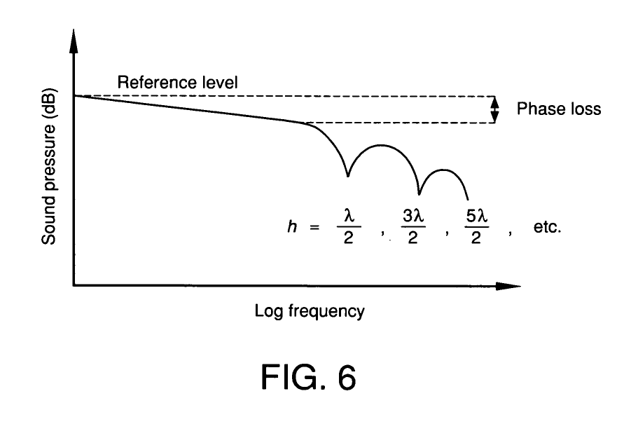

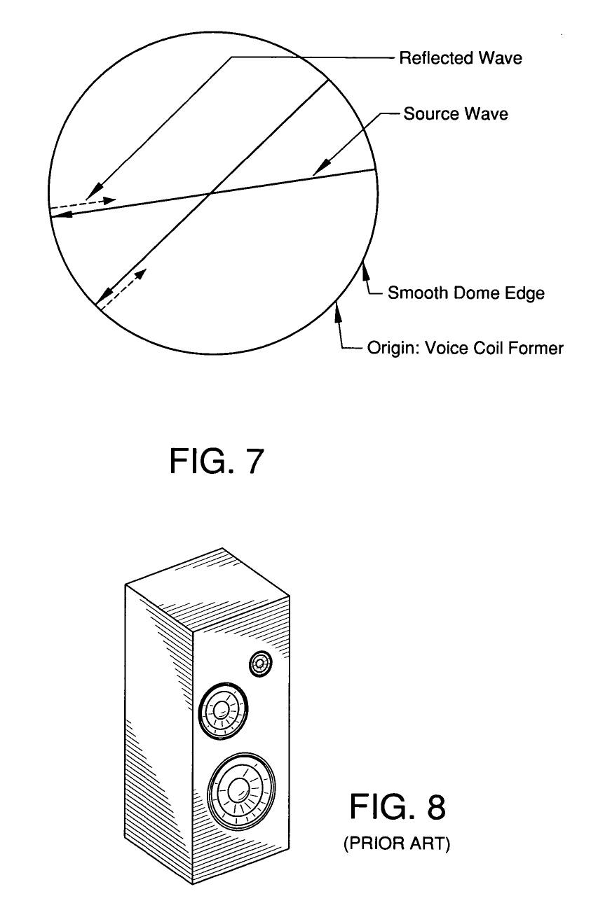

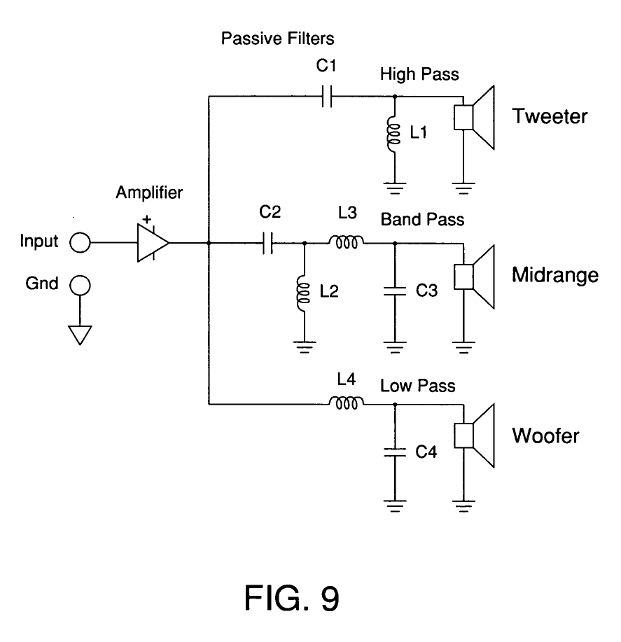

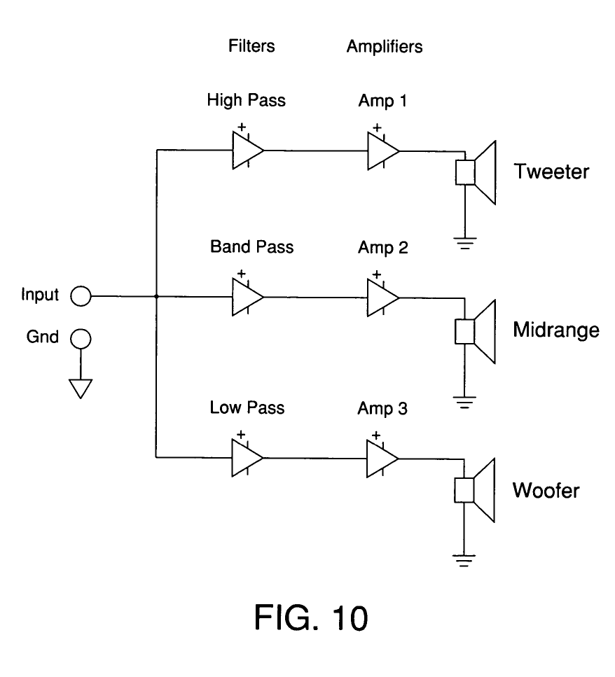

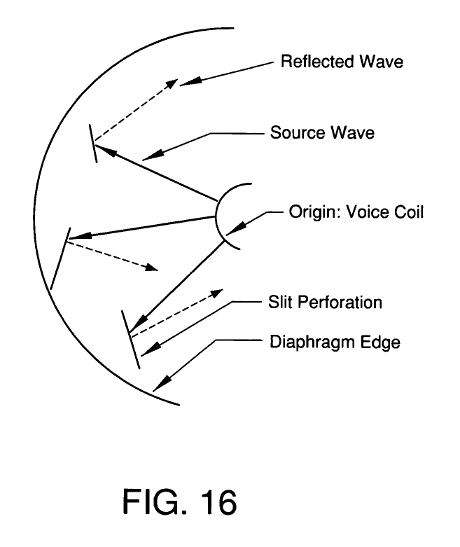

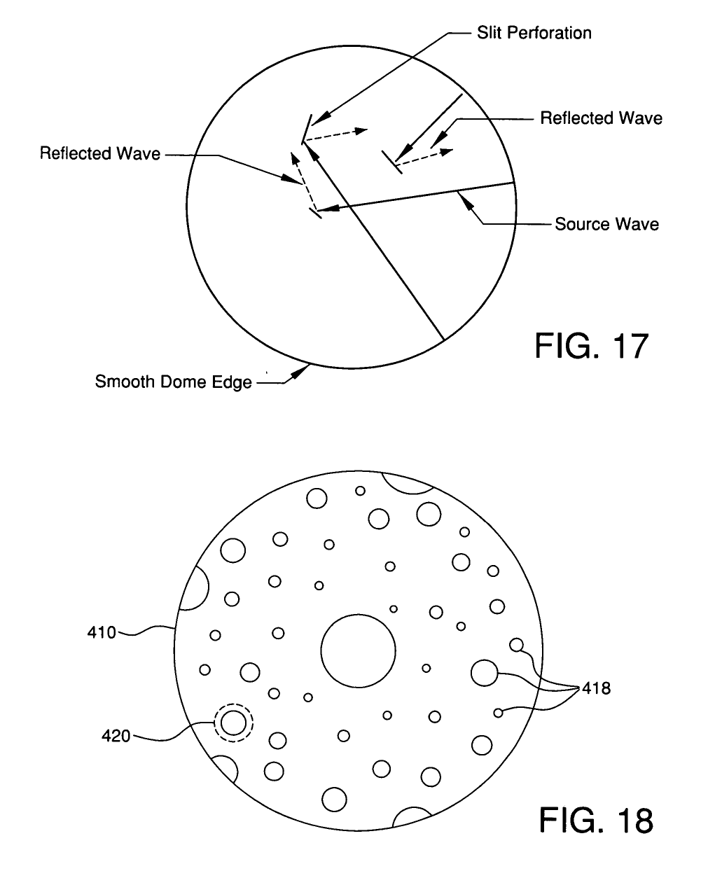

FIG. 15 illustrates a further embodiment of a cone-type speaker diaphragm 310 that relies upon a different category of resonance reducing surface irregularities being provided in the radiating surface of the diaphragm. According to this design, diaphragm 310 is perforated by a plurality of apertures 318. The apertures shown in FIG. 15 are preferably constructed as a plurality of one-dimensional slits. The slits may be randomly arranged about the radiating surface of the diaphragm. They may also be of the same or different lengths. Moreover, they may be arranged in a fixed pattern so long as the fixed pattern results in nodal resonance reduction. FIGS. 16 and 17 demonstrate how the provision of slitted apertures in cone-type and dome-type speaker diaphragms reduces deleterious resonances. Whereas FIGS. 4 and 7 show that smooth, uninterrupted radiating surfaces of conventional cone-type and dome-type speaker diaphragms reflect acoustic waves back toward the center of the diaphragms, thereby contributing to destructive resonances, FIGS. 16 and 17 show that acoustic waves of slitted diaphragms are reflected away from the diaphragms' centers, thereby eliminating resonances. The statistical density of the angular orientation of the slits 318 is another parameter that is constrained by the physical limitations of the diaphragm. Variables such as diaphragm size and fabrication material directly influence the optimal boundaries of any randomness applied to the perforations.

As a practical matter in the provision of perforations in cone-type diaphragms, the use of progressively smaller perforations toward the center of the cone yields the smallest reduction in the structural integrity of the cone. The setting of boundary constraints on randomness, such as size of the perforation relative to the center of the diaphragm, can be made to suit each individual application, allowing the designer to “tune” the loudspeaker diaphragm for optimal frequency response.

FIG. 18 depicts a variation on the theme of the apertured loudspeaker diaphragm discussed in connection with FIG. 15. According to this embodiment, a cone-type speaker diaphragm 410 is provided with a plurality of two-dimensional openings 418. As illustrated, openings 418 are circular in shape, although they may assume any shape or combination of shapes. Like slits 318, openings 418 may be randomly arranged about the radiating surface of the diaphragm. They may also be of the same or different sizes. And, they may be arranged in a fixed pattern so long as the fixed pattern results in nodal resonance reduction. The slits 318 or openings 418 may be provided in the diaphragms concurrently with or after diaphragm formation. It is also contemplated that a diaphragm may be provided with a combination of slits and openings to achieve the desired resonance reduction effect or design aesthetic, and the technique of randomizing the angle of perforation can be applied to all shapes or combination or shapes of perforations.

Another important practical consideration arising from the porous nature of a perforated loudspeaker diaphragm is the deleterious effect on low frequency response due to air leakage through the perforations. For any loudspeaker application with even modest low frequency requirements, the perforations need to be covered with sealant material. An example of sealant material covering an aperture is represented by dashed line 420 in FIG. 18. The primary objective of sealant material selection is to achieve an airtight seal with the perforated diaphragm, while not undermining the resonant reducing effects of the perforations. The present inventor has learned that suitable materials are those that are dissimilar from that of the diaphragm. Experience to date has yielded good results using silicon rubber to seal the perforations for diaphragm materials composed of plastic. The aperture sealant material may applied to either or both of the front and rear faces of the diaphragm.

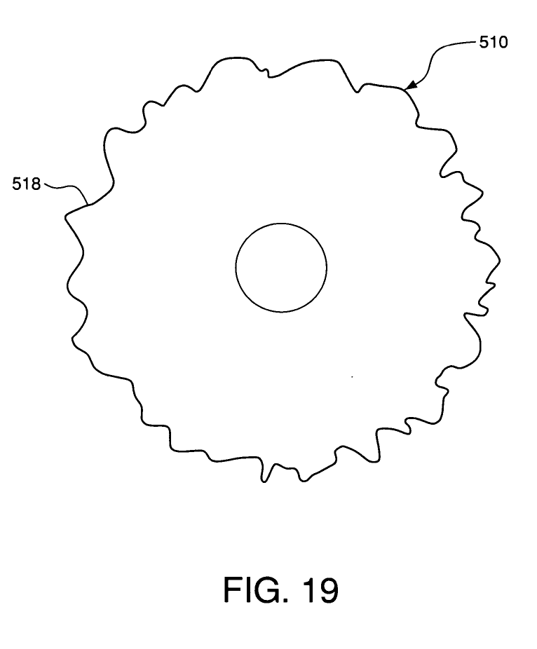

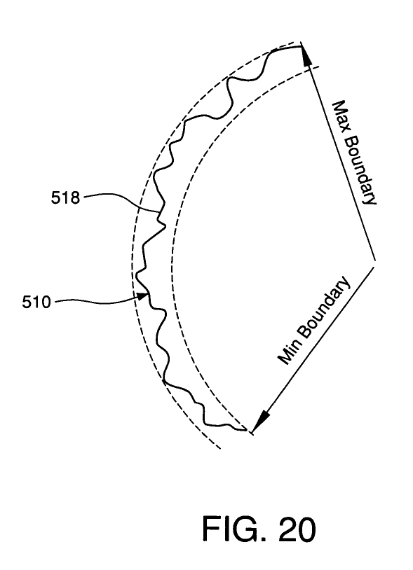

FIG. 19 reveals another example of surface irregularities that may be incorporated into a speaker diaphragm radiating surface in order to reduce undesirable resonances. According to that figure, diaphragm 510 is provided with an irregular or somewhat jagged edge 518 at its outer periphery where it is joined to the roll surround in the manner indicated in FIG. 1. FIG. 20 illustrates on an enlarged scale that the amplitude of the peaks and valleys in irregular edge 518 fall within defined minimum and maximum radial boundaries. The roll surround may be connected to the diaphragm so as to overlay or underlay the irregular edge 518. The radial overlap of the roll surround onto the diaphragm may range from about 1/5 inch to about 1 inch. In any event, the roll surround should extend to the minimum radial boundary of irregular edge 518 in order to prevent gaps between the roll surround and the diaphragm and their attendant air leakage performance problems.

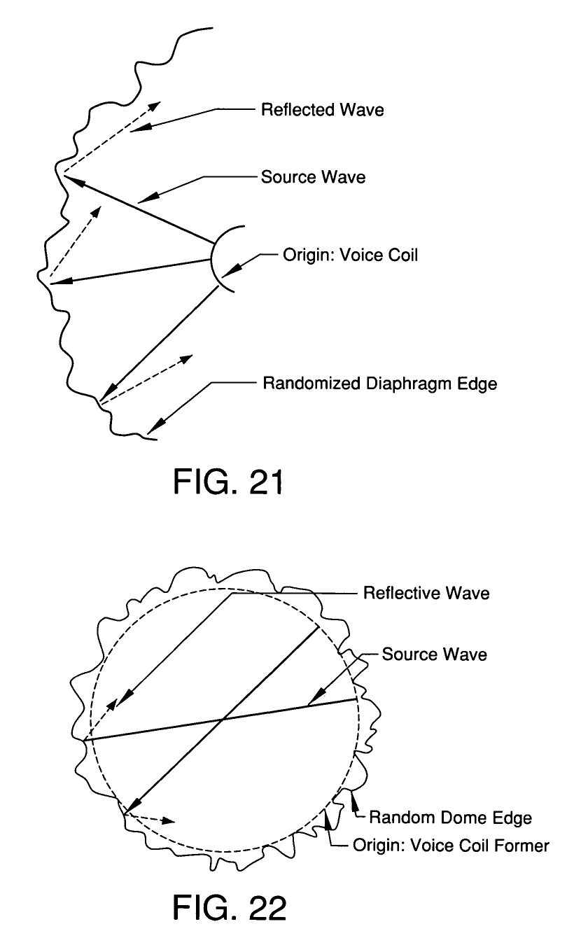

FIGS. 21 and 22 demonstrate how the provision of irregular edges 518 in cone-type (reference numeral 510, FIG. 21) and dome-type (reference numeral 510′, FIG. 22) speaker diaphragms reduces deleterious resonances. As seen in those figures, acoustic waves of irregularly-edged diaphragms are reflected away from the diaphragms' centers, thereby eliminating resonances. Variables such as diaphragm size and fabrication material directly influence the optimal boundaries of any randomness applied to the irregular edges 518. As with the earlier described radiating surface irregularities, the setting of boundary constraints on the randomness of irregular edges 518 can be made to suit each individual application, allowing the designer to “tune” the loudspeaker diaphragm for optimal frequency response. Conventional loudspeaker diaphragms with smooth regular edges tend to reinforce certain frequencies, while phase canceling others, resulting in an uneven frequency response and compromised sound reproduction. The randomized edge 518 of the present invention greatly reduces undesirable radially inwardly directed reflection of sound waves off of the edges of diaphragms. Moreover, it can be applied to any diaphragm shape, including cone, dome, flat panel, ellipse or any other shape which is required for a given sound reproduction application.

In addition to randomizing the radius of the diaphragm via irregular edge 518, it is also useful to randomize the angle of the rim or periphery of the diaphragm to further diffuse the reflected acoustic energy and reduce resonances. That is, where the diaphragm is connected to the roll surround, the randomized rim angle is the angle of the edge 518, relative to the normal of the cone's surface.

While edge-based randomness primarily addresses nodal resonances, the technique also assists in the reduction of bell mode resonances. Both of these phenomena are manifest in a manner that is proportional to the physical dimensions of the diaphragm, and both reduce the usable frequency range of a loudspeaker diaphragm.

Randomized edges can be employed with or without the use of the other randomized surface irregularities, (e.g., three-dimensional structural features and/or perforations) discussed hereinabove. However, the combination of randomized surface features with randomized edges can reduce or effectively eliminate the inherent resonant characteristics of a diaphragm's geometry.

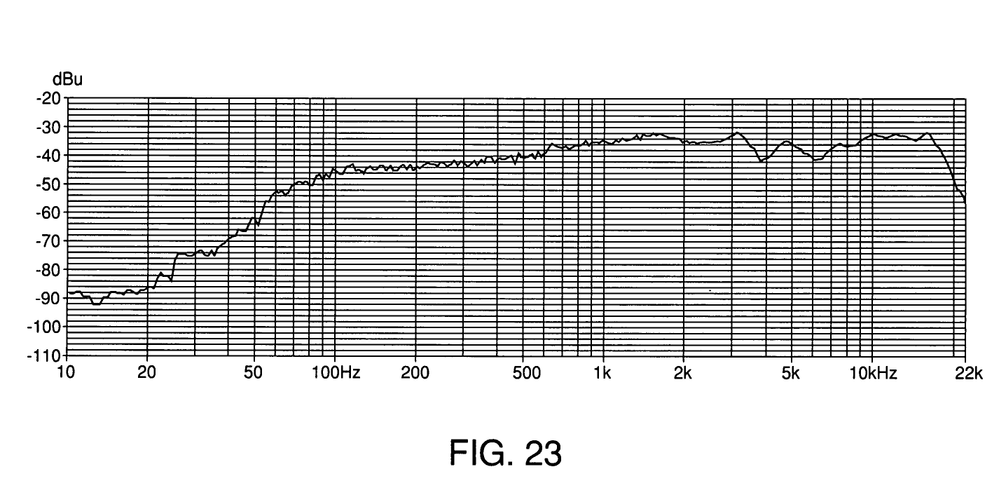

FIG. 23 is a frequency graph demonstrating the performance of a loudspeaker constructed according to the present invention. In particular, it is a performance graph of a 6-inch diameter, 1-inch deep cone-type driver whose diaphragm is provided with three-dimensional resonance reducing surface irregularities generally similar to those described in connection with FIGS. 11 and 12. As seen in FIG. 23, this small speaker delivers robust and substantially consistent performance from about 60 Hz (which approximates the frequency of the lowest frequency string of a bass guitar) to about 18 kHz (which is at the high end of the audible spectrum and exceeds the hearing capabilities of the majority of the human population).

A loudspeaker driver according to the present invention has significant advantages over the traditional multi-way loudspeaker systems. By eliminating a crossover system and its attendant phase shift, frequency response overlap and insertion (power loss), the instant invention represents a substantial improvement in the efficacy of a loudspeaker system. Additionally, by using a single driver, the preferred embodiment avoids physical separation of an array of differently sized drivers in a single loudspeaker enclosure that produces a components layout which is audible at typical user listening distances. For instance, a listener can hear a woofer operating separately from a tweeter in the same speaker enclosure. The advantages of a single driver capable of a wide frequency range are manifest when musical transients, common in music from sources such as vocal, stringed and, in particular, percussive instruments, are considered. Given the mathematical composition of even a brief transient signal, the harmonic series compromises a frequency range into the infinite. Even if a multi-way speaker system were capable of the necessary range, it is not possible for the listener's ear to be able to re-construct accurate transient information from an array of transducers physically displaced from one another in a manner consistent with currently available multi-way speaker systems.

Furthermore, speakers constructed in accordance with the present invention are small in size and therefore can be housed in correspondingly small enclosures. As a result, a very compact single-driver speaker system is achieved that is useful in virtually any room setting while avoiding the bulk, weight, and aesthetic disadvantages of multi-way speaker systems.

Although the invention has been described in detail for the purpose of illustration, it is to be understood that such detail is solely for that purpose and that variations can be made therein by those skilled in the art without departing from the spirit and scope of the invention as claimed herein.

1. An audio loudspeaker diaphragm comprising:
a radiating surface; and
resonance reducing surface irregularities provided on said radiating surface.

2. The diaphragm of claim 1 wherein said resonance reducing surface irregularities are randomly arranged on said radiating surface.

3. The diaphragm of claim 1 wherein said resonance reducing surface irregularities comprise three-dimensional structural features.

4. The diaphragm of claim 3 wherein said three-dimensional structural features comprise at least one of projections and depressions formed in relief with respect to said radiating surface.

5. The diaphragm of claim 3 wherein said three-dimensional structural features are randomly arranged on said radiating surface.

6. The diaphragm of claim 4 wherein said at least one of projections and depressions are randomly arranged on said radiating surface.

7. The diaphragm of claim 3 wherein said three-dimensional structural features comprise a plurality of formations extending radially outward from a center of said radiating surface.

8. The diaphragm of claim 7 wherein said at least one formation comprises a primary portion and progressively narrower secondary portions extending from said primary portion.

9. The diaphragm of claim 1 wherein said resonance reducing surface irregularities comprise apertures.

10. The diaphragm of claim 9 wherein said apertures comprise one-dimensional slits.

11. The diaphragm of claim 9 wherein said apertures comprise two-dimensional openings.

12. The diaphragm of claim 9 wherein said apertures are covered with sealant material.

13. The diaphragm of claim 9 wherein said apertures are of the same size.

14. The diaphragm of claim 9 wherein said apertures are of different sizes.

15. The diaphragm of claim 9 wherein said apertures are randomly arranged on said radiating surface.

16. The diaphragm of claim 9 wherein said apertures are arranged in a fixed pattern on said radiating surface.

17. The diaphragm of claim 9 wherein said apertures decrease in size toward a center of said radiating surface.

18. The diaphragm of claim 9 wherein said apertures comprise one-dimensional slits and two-dimensional openings.

19. The diaphragm of claim 1 wherein said resonance reducing surface irregularities comprise an irregular edge provided at an outer periphery of said radiating surface.

20. The diaphragm of claim 1 wherein said irregular edge is disposed at random angles with respect to the normal of said radiating surface.

21. The diaphragm of claim 1 wherein said resonance reducing surface irregularities comprise three-dimensional structural features and apertures.

22. The diaphragm of claim 1 wherein said resonance reducing surface irregularities comprise three-dimensional structural features and an irregular edge provided at an outer periphery of said radiating surface.

23. The diaphragm of claim 1 wherein said resonance reducing surface irregularities comprise apertures and an irregular edge provided at an outer periphery of said radiating surface.

24. The diaphragm of claim 1 wherein said resonance reducing surface irregularities comprise three-dimensional structural features, apertures and an irregular edge provided at an outer periphery of said radiating surface.

25. The diaphragm of claim 1 wherein the diaphragm is a cone-type diaphragm.

26. The diaphragm of claim 24 wherein the cone-type diaphragm includes a centrally located dust cap and wherein the dust cap is provided with resonance reducing surface irregularities.

27. The diaphragm of claim 1 wherein the diaphragm is a dome-type diaphragm.

28. An audio loudspeaker comprising the diaphragm of claim 1.
